(19) United States
(12) Patent Application Publication
(10) Pub. No.: US 2018/0172089 A1
(43) Pub. Date: Jun. 21, 2018

(54) CLUTCH CONTROL SYSTEM FOR A WORK VEHICLE TRANSMISSION

(71) Applicant: CNH Industrial America LLC, New Holland, PA (US)

(72) Inventor: Garth Harvey Bulgrien, Ephrata, PA (US)

(73) Assignee: CNH Industrial America LLC

(21) Appl. No.: 15/385,386

(22) Filed: Dec. 20, 2016

(51) Int. Cl. F16D 48/06; F16H 63/50

(52) U.S. Cl. CPC F16D 48/06; F16H 63/50; F16D 2500/10412; F16D 2500/111; F16D 2500/31406; F16D 2500/1045; F16D 2500/30415; F16D 2500/30426; F16D 2500/50221; F16D 2500/50287; F16D 2500/30806

(57) ABSTRACT

A clutch control system for a work vehicle includes a controller comprising a memory and a processor. The controller is configured to receive a first signal indicative of an inching pedal position and to determine a commanded inching torque based on the inching pedal position. The controller is configured to instruct an inching clutch to achieve the commanded inching torque while the commanded inching torque is less than a threshold inching torque. The controller is configured to instruct the inching clutch to achieve the threshold inching torque while the commanded inching torque is equal to or greater than the threshold inching torque. Herein the threshold inching torque is calculated based at least in part on a gear ratio established by engaging one or more clutches between an engine of the work vehicle and the inching clutch.

### BACKGROUND

The present disclosure relates generally to a clutch control system for a work vehicle transmission.

In certain work vehicles, such as a loader, a tractor, a grader, a backhoe, a forklift, or an agricultural vehicle, an inching clutch, which is controlled by an inching pedal or a clutch pedal, is used for inching (e.g., to position the work vehicle for connection to an implement) and for launching the work vehicle. The inching clutch has sufficient torque capacity to stall the engine of the work vehicle. The work vehicle transmission may also include powershift clutches upstream of the inching clutch (e.g., between the engine and the inching clutch) that allow selective engagement of one of several gear ratios upstream of the inching clutch. Each of the gear ratios results in a different value of inching clutch torque capacity required to be capable of stalling the engine. Since the inching clutch has sufficient torque capacity to stall the engine when using any of the available gear ratios, it has more torque capacity than necessary for some of the gear ratios. The powershift clutches also have sufficient torque capacity to stall the engine, but may not have sufficient torque capacity to overcome the full torque capacity of the inching clutch. In some transient conditions, this may result in the inching clutch overcoming one of the powershift clutches, causing excessive slippage in the powershift clutch. There may be a concern in a situation where the inching clutch has the torque capacity to stall the engine but the powershift clutches do not have the torque capacities to sustain the inching clutch torque. In particular, inching performed in higher gears (e.g., gears with lower gear ratios) may cause clutches upstream of the inching clutch to slip.

### BRIEF DESCRIPTION

In one embodiment, a clutch control system for a work vehicle includes a controller comprising a memory and a processor. The controller is configured to receive a first signal indicative of an inching pedal position and to determine a commanded inching torque based on the inching pedal position. The controller is configured to instruct an inching clutch to achieve the commanded inching torque while the commanded inching torque is less than a threshold inching torque. The controller is configured to instruct the inching clutch to achieve the threshold inching torque while the commanded inching torque is equal to or greater than the threshold inching torque. Herein the threshold inching torque is calculated based at least in part on a gear ratio established by engaging one or more clutches between an engine of the work vehicle and the inching clutch.

In another embodiment, a method for controlling an inching clutch of a work vehicle includes receiving a first signal indicative of an inching pedal position and determining a commanded inching torque based on the inching pedal position. The method includes instructing the inching clutch to achieve the commanded inching torque while the commanded inching torque is less than a threshold inching torque. The method also includes instructing the inching clutch to achieve the threshold inching torque while the commanded inching torque is equal to or greater than the threshold inching torque. Herein the threshold inching torque is calculated based at least in part on a gear ratio established by engaging one or more clutches between an engine of the work vehicle and the inching clutch.

In a further embodiment, an apparatus includes at least one non-transitory memory storing instructions for execution by a processor. The instructions include instructions to receive a first signal indicative of an inching pedal position and instructions to determine a commanded inching torque based on the inching pedal position. The instructions include instructions to instruct the inching clutch to achieve the commanded inching torque while the commanded inching torque is less than a threshold inching torque. The instructions include instructions to instruct the inching clutch to achieve the threshold inching torque while the commanded inching torque is equal to or greater than the threshold inching torque. The threshold inching torque is sufficient to stall an engine of a work vehicle at a gear ratio established by engaging one or more clutches upstream of the inching clutch and is less than a torque sufficient to slip the engaged one or more clutches upstream of the inching clutch.

### DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of a work vehicle that may employ a transmission system, in accordance with the present disclosure;

FIG. 2 is a block diagram of an embodiment of a transmission system that may be used in the work vehicle of FIG. 1, in accordance with the disclosure;

FIG. 3 is a schematic diagram of an embodiment of a transmission that may be used within the transmission system of FIG. 2;

FIG. 4 is an embodiment of a table that may be used to determine a threshold inching torque of an inching clutch of the transmission of FIG. 3; and

FIG. 5 is a flow chart of an embodiment of a method for controlling the inching clutch based in part on a threshold inching torque.

### DETAILED DESCRIPTION

A controlled inching process may be utilized in a transmission system of a work vehicle to substantially reduce or eliminate slipping of powershift clutches. When a work vehicle is inching, a clutch pressure or clamp load is applied to engage an inching clutch, resulting in an inching torque (τ_{inching}), which generally increases as the applied clutch pressure or clamp load increases. A threshold inching torque (υ_{threshold}) may be calculated for each of the available gear ratios between the engine and the inching clutch, such that τ_{threshold} is sufficient to stall an engine of the work vehicle, but low enough to avoid slipping of the engaged powershift clutches upstream of the inching clutch. Accordingly, the engagement of the inching clutch (e.g., pressure or clamp load applied to the inching clutch) may be controlled (e.g., via a controller) based in part on the determined τ_{threshold}, such that the powershift clutches upstream of the inching clutch do not slip when the work vehicle is inching.

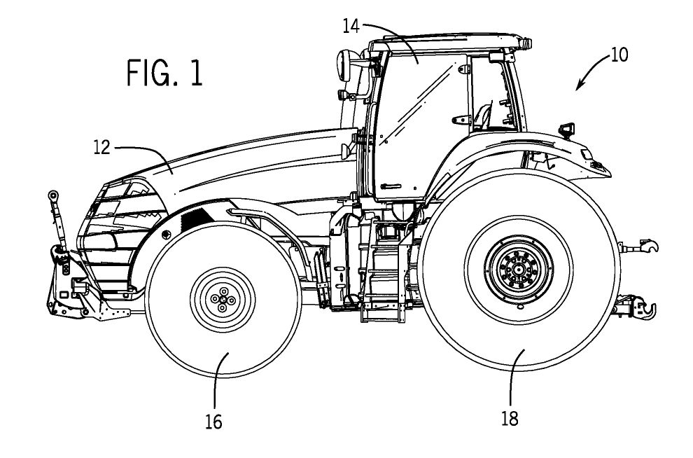

Turning now to the drawings, FIG. 1 is a side view of an embodiment of a work vehicle 10 that may employ a transmission system. While the illustrated work vehicle is a tractor, it should be appreciated that the work vehicle 10 may be any suitable type of loader, grader, backhoe, forklift, agricultural vehicle, or any other suitable work vehicle that utilizes a transmission. The work vehicle 10 has a body 12 that typically houses an engine, transmission, and power train. Further, the work vehicle 10 has a cabin 14 where an operator may sit or stand to operate the work vehicle 10. The work vehicle 10 has two front wheels 16 and two rear wheels 18 that rotate to move the work vehicle 10. In alternative embodiments, the work vehicle 10 may have tracks (one or two tracks on each side) instead of wheels. The work vehicle 10 may drive the wheels 16 and/or 18 using a transmission. For example, the work vehicle 10 may use a powershift transmission system to transfer power from the engine to the wheels 16 and/or 18.

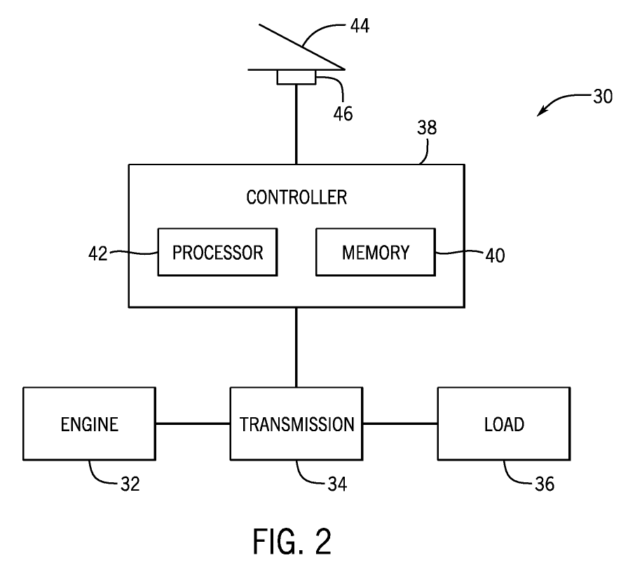

FIG. 2 is a block diagram of an embodiment of a transmission system 30 that may be used in the work vehicle 10 of FIG. 1. An engine 32 (e.g., an internal combustion engine) provides power to drive a transmission 34 of the transmission system 30. The transmission 34 may include a hydraulic system, a planetary gear unit, seals and gaskets, a torque converter, a modulator, and sensor(s), among other suitable components. Output from the transmission 34 drives a load 36, such as the wheels 16 and 18 of the work vehicle 10. In the illustrated embodiment, the transmission system 30 includes a controller 38 configured to control various systems and units within the transmission 34. The controller 38 includes one or more memory device(s) 40 and one or more processor(s) 42. For example, the memory device(s) 40 may include volatile memory, such as random access memory (RAM), and/or non-volatile memory, such as read-only memory (ROM), optical drives, hard disc drives, solid-state drives, or a combination thereof. Additionally, the one or more processor(s) 42 may include one or more application specific integrated circuits (ASICs), one or more field programmable gate arrays (FPGAs), one or more general purpose processors, or any combination thereof. Furthermore, the term “processor” is not limited to just those integrated circuits referred to in the art as processors, but broadly refers to computers, processors, microcontrollers, microcomputers, programmable logic controllers, ASICs, and other programmable circuits. The memory device(s) 40 (e.g., non-transitory computer-readable medium/memory circuitry) may store one or more sets of instructions (e.g., processor-executable instructions), which may be implemented to operate the transmission 34. In operation, the controller 38 uses the processor(s) 42 to execute instructions stored in the memory device(s) 40 to control the transmission 34. For example, the controller 38 may receive instructions to cause various clutches to be engaged/disengaged to cause gear ratio changes while the work vehicle 10 is moving (e.g., at different speeds). The transmission system 30 also includes an inching pedal 44 and a sensor 46 coupled to the inching pedal 44. The sensor 46 is configured to output a signal indicative of a position of the inching pedal 44. For example, a degree of deflection/position of the inching pedal 44 is detected by the sensor 46 and input (e.g., signal transmitted) to the controller 38 to facilitate inching controlling. For example, the controller may control the pressure or clamp load applied to an inching clutch of the transmission 34 based at least in part on the position of the inching petal 44.

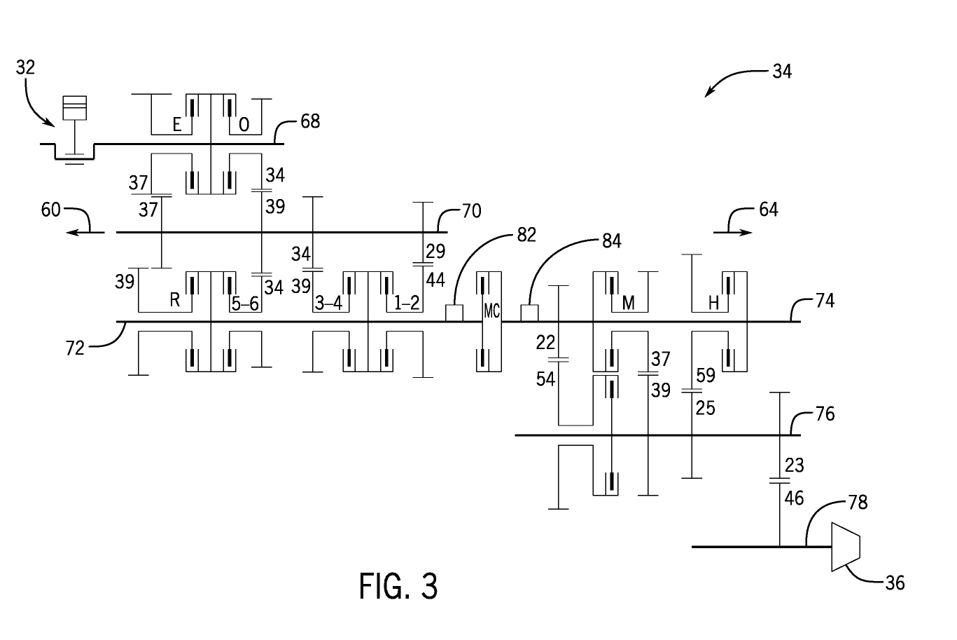

FIG. 3 is a schematic diagram of an embodiment of a transmission 34 that may be used within the transmission system of FIG. 2. In the following descriptions, an axial direction 60 pointing toward the drive motor (e.g., engine 32) is referred to as “front”, whereas an axial direction 64 pointing toward the load 36 is referred to as “rear”. In the illustrated embodiment, the transmission 34 includes an input shaft 68 driven by the engine 32, a first counter shaft 70, a second counter shaft 72, a third counter shaft 74, a fourth counter shaft 76, and an output shaft 78 that outputs power to the load 36. An inching clutch MC selectively couples the second counter shaft 72 to the third counter shaft 74. The inching clutch MC may be disengaged, partially engaged (e.g., slipping), and fully engaged (e.g., locked-up).

The transmission 34 includes a first speed sensor 82 and a second speed sensor 84, each configured to output a respective signal indicative of the rotational speed of the respective shaft. For example, the first speed sensor 82 may measure rotational speed of the second counter shaft 72 (e.g., an upstream shaft with respect to the inching clutch MC), and the second speed sensor 84 may measure rotational speed of the third counter shaft 74 (e.g., a downstream shaft with respect to the inching clutch MC). It may be appreciated that the first and second speed sensors 82 and 84 may include reflective sensor(s), interrupter sensor(s), optical sensor(s), magnetic sensor(s), Hall-effect sensor(s), other suitable type(s) of sensor(s) or a combination thereof. The speed sensors 82 and 84 may continuously, periodically, or upon receiving an instruction from the controller 38, measure and output signals indicative of rotational speed to the controller 38. The controller 38 may determine that the inching clutch MC is locked-up when the rotational speed measured by the first speed sensor 82 is equal to or substantially equal to (e.g., within a tolerance of) the rotational speed measured by the second speed senor 84 (e.g., indicating that the second and third counter shafts 72 and 74 are rotating at the same or substantially the same speed). Alternatively, the speed of the second counter shaft 72 and/or the speed of the third counter shaft 74 may be measured by one or more speed sensors disposed at any other suitable locations, and the speed of the shaft of interest may be calculated based on gear ratios (e.g., established by engaging clutches upstream of the inching clutch). For example, a speed sensor may be disposed on the output shaft 78 to measure the rotational speed of the output shaft 78, and together with an engine speed (e.g., determined via a control area network or can bus), the speed of the counter shaft 72 may be calculated.

The transmission 34 also includes multiple powershift clutches upstream (e.g., in the axial direction 60) and downstream (e.g., in the axial direction 64) of the inching clutch MC. These powershift clutches are configured to selectively connect the input shaft 68 to the output shaft 78 at multiple forward or reverse gear speed ratios. As illustrated, the powershift clutches upstream of the inching clutch MC include an even clutch E and an odd clutch O disposed on the input shaft 68, and a reverse clutch R and clutches 5-6, 3-4, and 1-2 disposed on the second counter shaft 72.

The powershift clutches upstream of the inching clutch MC may be susceptible to slipping (e.g., excessive slippage) because the inching clutch MC torque capacity that is required for the largest gear reduction upstream of the inching clutch MC may exceed the maximum torque capacities of the powershift clutches that are used for smaller gear reductions upstream of the inching clutch MC, causing the powershift clutches to slip. To substantially reduce or eliminate the possibility of slipping the clutches upstream of the inching clutch MC, a controlled inching process may be employed. For example, when the work vehicle 10 is inching, the engagement of the inching clutch MC (e.g., pressure or clamp load applied to the inching clutch MC) is controlled, such that the torque capacities of the powershift clutches upstream of the inching clutch MC are not exceeded. In certain embodiments, a torque threshold (τ_{threshold}) of the inching clutch MC may be determined for each available gear ratio between engine 32 and the inching clutch MC, such that the inching clutch MC has an inching torque (τ_{inching}) sufficient to stall the engine 32, but low enough to substantially reduce or eliminate the possibility of slipping the engaged powershift clutches upstream of the inching clutch MC (e.g., clutches E, O, R, 1-2, 3-4, and 5-6), then the inching clutch MC is controlled to not exceed τ_{threshold}.

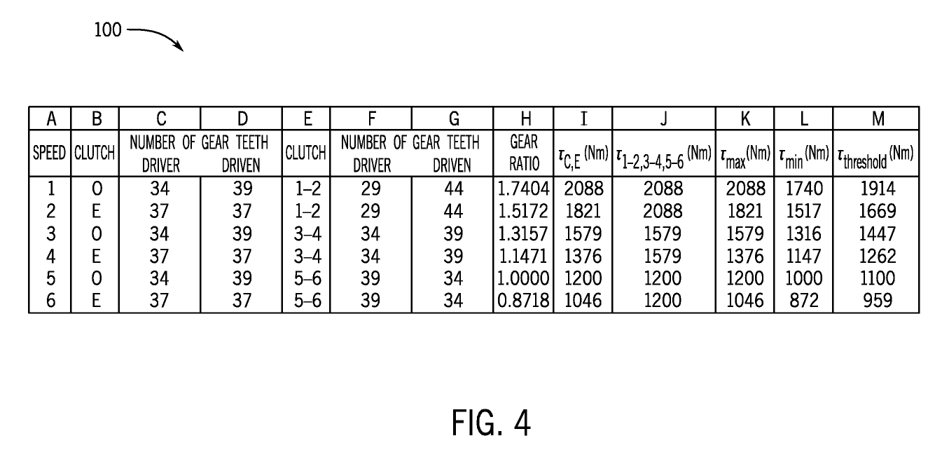

FIG. 4 is an embodiment of a table 100 that may be used to determine the threshold inching torque (τ_{threshold}) of the inching clutch MC based at least in part on torque capacities of the powershift clutches upstream of the inching clutch MC. In the illustrated embodiment, the peak input torque provided by the engine 32 is assumed to be 1000 newton meter (Nm), and a safety factor of 1.2 is used, such that the clutch E and clutch O each has a torque capacity of 1200 Nm (e.g., 1000 Nm×1.2=1200 Nm). Speed 1 to Speed 6 (e.g., forward speeds) are presented in successive rows with each achievable via the transmission 34 of FIG. 3 when the powershift clutches upstream of the inching clutch MC are selectively engaged. Column A designates the speed, and column B and column E each designates the engaged clutches. For example, Speed 1 is achieved by engaging clutch O and clutch 1-2, Speed 2 is achieved by engaging clutch E and clutch 1-2, and so on (e.g., engaged clutches are indicated in column B and column E).

Column C, column D, column F, and column G, each designates a number of gear teeth for a gear contributing to the transmission gear ratio. Correspondingly, column H designates a gear ratio (e.g., between the engine 32 and the inching clutch MC) based on the coupled gears set forth in columns B and E. For example, for Speed 1, the driver and driven gears coupled to the engaged clutch O have 34 and 39 teeth, respectively, and the driver and driven gears coupled to the engaged clutch 1-2 have 29 and 44 teeth, respectively. As the result, the gear ratio (e.g., between the engine 32 and the inching clutch MC) is calculated to be 1.7404 (e.g., 39/34×44/29=1.7404). For Speed 2, the driver and driven gears coupled to the engaged clutch E have 37 and 37 teeth, respectively, and the driver and driven gears coupled to the engaged clutch 1-2 have 29 and 44 teeth, respectively. As the result, the gear ratio (e.g., between the engine 32 and the inching clutch MC) is calculated to be 1.5172 (e.g., 37/37×44/29=1.5172).

Column I designates (e.g., for each of the six speeds) a torque value (-cox) at the inching clutch MC that would result in slipping of the clutch O or the clutch E because τ_{O,E} at the inching clutch induces the maximum torque capacity of the clutch O or the clutch E to be applied to the clutch O or the clutch E. The value of τ_{O,E} for each speed is calculated by multiplying the torque capacity of the clutch E or clutch O (e.g., 1200 Nm) by the calculated gear ratio as set forth above. For example, for Speed 1, τ_{O,E} (e.g., clutch O engaged) is calculated to be 2088 Nm (e.g., 1200 Nm×1.7404=2088 Nm). For Speed 2, τ_{O,E} (e.g., clutch E engaged) is calculated to be 1821 Nm (e.g., 1200 Nm×1.5172=1821 Nm).

Column J designates (e.g., for each of the six speeds) a torque value (τ_{1-2,3-4,5-6}) at the inching clutch MC that would result in slipping of the clutch 1-2, the clutch 3-4, or the clutch 5-6 because τ_{1-2,3-4,5-6} at the inching clutch MC induces the maximum torque capacity of the clutch 1-2, the clutch 3-4, or the clutch 5-6 to be applied to the clutch 1-2, the clutch 3-4, or the clutch 5-6, respectively. It may be appreciated that because the clutch 1-2, the clutch 3-4, and the clutch 5-6 are on the same shaft as the inching clutch MC and there is no additional gear ratio to be considered, the torque that would cause the clutches upstream of the inching clutch to slip is their respective torque capacity. For example, for Speed 1 and Speed 2, τ_{1-2,3-4,5-6} is the torque capacity of the clutch 1-2, which is 2088 Nm. For example, for Speed 3 and Speed 4, τ_{1-2,3-4,5-6} is the torque capacity of the clutch 3-4, which is 1579 Nm.

Column K designates (e.g., for each of the six speeds) a maximum value of torque (τₘₐₓ) for the torque threshold at the inching clutch MC, above which at least one of the clutches upstream of the inching clutch MC may slip. τₘₐₓ is the lower of the τ_{O,E} and τ_{1-2,3-4,5-6}. For example, for Speed 1, τₘₐₓ is 2088 Nm, which is the lower of 2088 Nm (e.g., τ_{O,E} in column I) and 2088 Nm (e.g., τ_{1-2,3-4,5-6} in column J). For Speed 2, τₘₐₓ is 1821 Nm, which is the lower of 1821 Nm (e.g., τ_{O,E} in column I) and 2088 Nm (e.g., τ_{1-2,3-4,5-6} in column J).

Column L designates (e.g., for each of the six speeds) a minimum value of torque (τₘᵢₙ) for the torque threshold at the inching clutch MC, such that the inching clutch MC has sufficient torque capacity to stall the engine. Accordingly, τₘᵢₙ is calculated by multiplying the peak input torque from the engine 32 (e.g., 1000 Nm) by the gear ratio shown in column H (e.g., between the engine 32 and the inching clutch MC). For example, for Speed 1, τₘᵢₙ is 1740 Nm (e.g., 1000 Nm×1.7404=1740 Nm). For Speed 2, τₘᵢₙ is 1517 Nm (e.g., 1000 Nm×1.5172=1517 Nm).

As set forth above, a controlled inching process may be utilized for controlling the engagement of the inching clutch MC to substantially reduce or eliminate the possibility of slipping the powershift clutches upstream of the inching clutch MC. In the illustrated embodiment, the inching clutch MC is controlled such that the inching torque τ_{inching} does not exceed τ_{threshold}. Note that τ_{threshold} is selected such that it is above τₘᵢₙ and therefore sufficient to stall the engine 32 at all of the available gear ratios between the engine 32 and the inching clutch MC, and below τₘₐₓ to substantially reduce or eliminate the possibility of slipping the powershift clutches upstream of the inching clutch MC. For each speed, τ_{threshold} as shown in Column M is calculated based on the τₘₐₓ and τₘᵢₙ values in columns K and L. For example, τ_{threshold} may be calculated as the average of the τₘₐₓ and τₘᵢₙ values, such that τ_{threshold} is higher than τₘᵢₙ but lower than τₘₐₓ. It may be appreciated that for each speed, τ_{threshold} is higher than τₘᵢₙ such that the peak input torque (e.g., from the engine) may be fully utilized, and τ_{threshold} is lower than τₘₐₓ, such that the possibility of slipping the engaged upstream powershift clutches (e.g., clutches O, E, 1-2, 3-4, and 5-6) is substantially reduced or eliminated. Alternatively, τ_{threshold} may be any suitable value greater than τₘᵢₙ and less than τₘₐₓ.

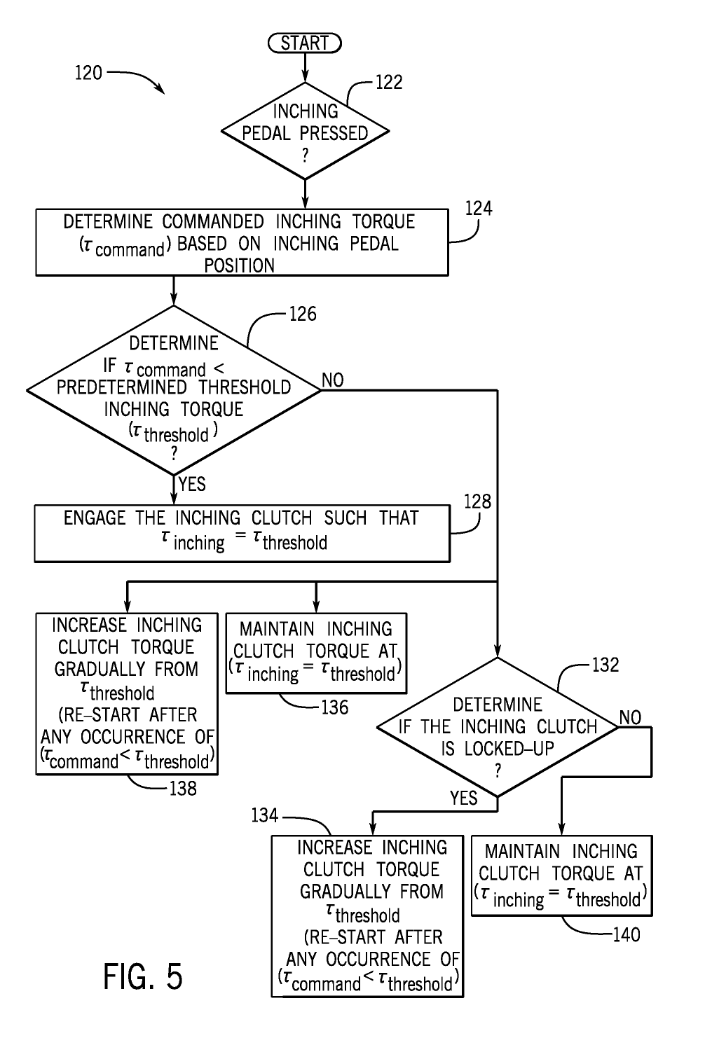

FIG. 5 is a flow chart of an embodiment of a method 120 for controlling the inching clutch MC based in part on the predetermined threshold inching torque τ_{threshold}. One or more of the steps of the method 120 may be executed by the controller. The method 120 begins at step 122 by sensing (e.g., via the sensor) if the inching pedal is pressed. When the inching pedal is pressed, at step 124 the controller determines a commanded inching torque (τ_{command}) based on the depressed inching pedal position. In the illustrated embodiment, when a user or operator depresses the inching pedal, the controller receives a signal from the sensor. Based on the received signal from the sensor, the controller determines the commanded inching torque τ_{command} to achieve a corresponding pressure or clamp load (e.g., based on the inching pedal position detected by the sensor). At step 126, the controller determines if τ_{command} is less than τ_{threshold}. If τ_{command} is less than τ_{threshold}, the controller instructs the inching clutch MC to achieve a τ_{inching} that is equal to τ_{command} at step 128. However, if τ_{command} is equal to or greater than τ_{threshold}, the controller instructs the inching clutch MC to achieve a τ_{inching} that is equal to τ_{threshold} at steps 136 and 140 or to gradually increase τ_{inching} from τ_{threshold} in steps 134 and 138. For example, even if the user or operator requests a higher inching torque such that τ_{command} is greater than τ_{threshold}, the controller may overwrite the user or operator commanded τ_{command} and instruct the inching clutch MC to achieve a τ_{inching} that is equal to τ_{threshold}, or subsequently increase τ_{inching} from τ_{threshold}. The steps 124, 126, 128, 134, 136, 138, and 140 may cause τ_{inching} to remain less than or equal to τ_{threshold} until further instruction(s) are given by the controller (e.g., steps 134 and 138). It should be noted that the one or more of the steps (e.g., steps 122 through 140) of the method 120 may be executed repeatedly by the controller. For example, the one or more of the steps of the method 120 may be repeatedly executed in any suitable frequencies, such as about 100 times per second. For example, the one or more of the steps of the method 120 may be repeatedly executed every time τ_{command} has changed. In certain embodiments, the τ_{command} may be instructed from an automated system instead of by user depressing an inching pedal.

Once the inching clutch MC is engaged such that τ_{inching}=τ_{command} or τ_{threshold}, and if the controller determines that τ_{command} is greater than τ_{threshold} at step 126, the controller may check for lock-up of the inching clutch MC at step 132. Upon the determination that the inching clutch MC is locked-up, the controller may subsequently instruct the inching clutch MC to increase τ_{inching} (e.g., increase the pressure or clamp load) gradually at step 134. For example, the controller may instruct the inching clutch MC to increase τ_{inching} from τ_{threshold} (e.g., to τₘₐₓ, torque capacity of the inching clutch MC, or any other suitable values). It should be noted that if any time the τ_{command} becomes less than τ_{threshold} (e.g., as the operator may move the inching petal position), the controller may restart the process at step 122 as set forth above. In the illustrated embodiment, the controller may determine that the inching clutch MC is locked-up when the rotational speed of second countershaft 72 is equal to or substantially equal to the rotational speed of third countershaft 74. If the inching clutch MC is not determined to be locked-up at step 132, the controller may limit τ_{command} to τ_{threshold} at step 140.

Alternatively, once the inching clutch MC is engaged such that τ_{inching} =τ_{command} or τ_{threshold}, and if the controller determines that τ_{command} is greater than τ_{threshold} at step 126, the controller 38 may continuously limit τ_{inching} to τ_{threshold} at step 136 without checking for clutch lock-up. Alternatively, once the inching clutch MC is engaged such that τ_{inching}=τ_{command} or τ_{threshold}, and if the controller determines that τ_{command} is greater than τ_{threshold} at step 126, the controller may increase τ_{inching} (e.g., increase the pressure or clamp load) gradually at step 138 without checking for clutch lock-up. For example, τ_{inching} may be increased gradually from τ_{threshold} (e.g., to τₘₐₓ, torque capacity of the inching clutch MC, or any other suitable values) at step 138. It should be noted that if any time the τ_{command} becomes less than τ_{threshold} (e.g., as the operator may move the inching petal position), the controller may restart the process at step 122 as set forth above.

While only certain features have been illustrated and described herein, many modifications and changes will occur to those skilled in the art. It is, therefore, to be understood that the appended claims are intended to cover all such modifications and changes as fall within the true spirit of the invention.

1. A clutch control system for a work vehicle, comprising:
a controller comprising a memory and a processor, wherein the controller is configured to receive a first signal indicative of an inching pedal position, to determine a commanded inching torque based on the inching pedal position, and to instruct an inching clutch to achieve the commanded inching torque while the commanded inching torque is less than a threshold inching torque and to instruct the inching clutch to achieve the threshold inching torque while the commanded inching torque is equal to or greater than the threshold inching torque, wherein the threshold inching torque is calculated based at least in part on a gear ratio established by engaging one or more clutches between an engine of the work vehicle and the inching clutch.

2. The clutch control system of claim 1, wherein the threshold inching torque is sufficient to stall an engine of the work vehicle at a gear ratio established by engaging one or more clutches upstream of the inching clutch and is less than a torque sufficient to slip the engaged one or more clutches upstream of the inching clutch.

3. The clutch control system of claim 1, wherein the controller is configured to subsequently instruct the inching clutch to gradually increase an inching torque.

4. The clutch control system of claim 1, comprising:
a first sensor disposed on an input shaft to the inching clutch, wherein the first sensor is configured to output speed of the input shaft; and
a second sensor disposed on an output shaft from the inching clutch, wherein the second sensor is configured to output speed of the output shaft,
wherein the inching clutch is determined to be locked-up while the speed of the input shaft is substantially equal to the speed of the output shaft.

5. The clutch control system of claim 4, wherein the input shaft and the output shaft are selectively coupled to one another via engagement of the inching clutch, and the controller is configured to receive signals indicative of speeds of the input shaft and the output shaft to determine lock-up of the inching clutch.

6. The clutch control system of claim 1, wherein the controller is configured to instruct the inching clutch to maintain the threshold inching torque.

7. The clutch control system of claim 4, wherein the controller is configured to instruct the inching clutch to increase torque upon a determination that the inching clutch is locked-up.

8. A method for controlling an inching clutch of a work vehicle, comprising:
receiving a first signal indicative of an inching pedal position;
determining a commanded inching torque based on the inching pedal position;
instructing the inching clutch to achieve the commanded inching torque while the commanded inching torque is less than a threshold inching torque; and
instructing the inching clutch to achieve the threshold inching torque while the commanded inching torque is equal to or greater than the threshold inching torque, wherein the threshold inching torque is calculated based at least in part on a gear ratio established by engaging one or more clutches between an engine of the work vehicle and the inching clutch.

9. The method of claim 8, wherein the threshold inching torque is sufficient to stall an engine of the work vehicle at a gear ratio established by engaging one or more clutches upstream of the inching clutch and is less than a torque sufficient to slip the engaged one or more clutches upstream of the inching clutch.

10. The method of claim 8, comprising:
subsequently instructing the inching clutch to gradually increase an inching torque.

11. The method of claim 8, comprising determining whether the inching clutch is locked-up.

12. The method of claim 11, wherein determining whether the inching clutch is locked-up comprising:
receiving a second signal indicative of a first rotational speed of an input shaft to the inching clutch;
receiving a third signal indicative of a second rotational speed of an output shaft from the inching clutch, wherein the input shaft and the output shaft are selectively coupled to one another via engagement of the inching clutch; and
comparing the first rotational speed to the second rotational speed, wherein the inching clutch is determined to be locked-up while the first rotational speed is substantially equal to the second rotational speed.

13. The method of claim 8, comprising instructing the inching clutch to maintain the threshold inching torque.

14. The method of claim 11, comprising instructing the inching clutch to increase inching torque after determining that the inching clutch is locked-up.

15. An apparatus comprising:
at least one non-transitory memory storing instructions for execution by a processor, the instructions comprising:
instructions to receive a first signal indicative of an inching pedal position;
instructions to determine a commanded inching torque based on the inching pedal position;
instructions to instruct the inching clutch to achieve the commanded inching torque while the commanded inching torque is less than a threshold inching torque; and
instructions to instruct the inching clutch to achieve the threshold inching torque while the commanded inching torque is equal to or greater than the threshold inching torque, wherein the threshold inching torque is sufficient to stall an engine of a work vehicle at a gear ratio established by engaging one or more clutches upstream of the inching clutch and is less than a torque sufficient to slip the engaged one or more clutches upstream of the inching clutch.

16. The apparatus of claim 15, wherein the instructions comprising:
instructions to subsequently instruct the inching clutch to achieve a maximum inching torque.

17. The apparatus of claim 15, wherein the instructions comprising:
instructions to determine if the inching clutch is locked-up.

18. The apparatus of claim 17, wherein instructions to determine if the inching clutch is locked-up comprises:
instructions to measure a speed indicative of the speed of an input shaft to the inching clutch;
instructions to measure a speed indicative of the speed of an output shaft from the inching clutch, wherein the input shaft and the output shaft are selectively coupled to one another via engagement of the inching clutch; and
instructions to compare the speed of the input shaft to the speed of the output shaft, wherein the inching clutch is determined to be locked-up while the speed of the input shaft is substantially equal to the speed of the output shaft.

19. The apparatus of claim 15, wherein the instructions comprising:
instructions to instruct the inching clutch to maintain the threshold inching torque.

20. The apparatus of claim 18, wherein the instructions comprising:
instructions to instruct the inching clutch to increase an inching torque after determining that the inching clutch is locked-up.
